(19) United States
(12) Patent Application Publication
(10) Pub. No.: US 2017/0361206 A1
(43) Pub. Date: Dec. 21, 2017

(54) Seven Hits

(71) Applicant: Roman Jirku, Costa Mesa, CA (US)

(72) Inventor: Roman Jirku, Costa Mesa, CA (US)

(21) Appl. No.: 15/619,472

(22) Filed: Jun. 10, 2017

Related U.S. Application Data
(60) Provisional application No. 62/352,083, filed on Jun. 20, 2016.

(51) Int. Cl. A63F 1/00; G07F 17/32

(52) U.S. Cl. CPC A63F 1/00; G07F 17/3288

(57) ABSTRACT

Seven Hits is a card game which provides an opportunity for players at a casino to win a prize by each player placing a bet one time on one card or any of the 32 cards displayed on the Seven Hits playing field. The game includes a fixed pool of game plays and a predetermined number of winning plays within each pool. A method of playing Seven Hits casino card game comprises providing a standard 32 (from 7 to Ace from each suit).

### BACKGROUND OF INVENTION

Many different wagering games presently exist for use in both home and casino environments. Such games should necessarily be exciting, uncomplicated, and easy to learn to avoid frustrating players. Designing new games that meet these criteria and are sufficiently different from old games to entice players to play the new games.

The invention is directed to wagering games, and more particularly, table games typically found in gaming establishments, such as those involving a playing surface, playing positions for multiple players, playing cards, and a dealer.

### SUMMARY OF THE INVENTION

Therefore, it is an object of this invention to provide a card game which is entertaining to play.

Another object of this invention is to provide such a card game which appears to have reasonable odds in favor of the player.

Still another object of this invention is to provide such a card game in which the odds of winning are actually unvarying in favor of the casino or dealer.

Still another object of the invention is to provide such a card game in which a player plays against himself rather than against a hand held by the dealer or another player.

Still further objects and advantages of this invention shall become apparent from the ensuing descriptions of the invention.

Accordingly, a card game is provided, utilizing a master deck including a 32-card deck of standard playing cards, then a dealer shuffles a deck of cards, and then dealer picks 2 cards from the deck called “Sleeping Cards”. Sleeping cards can be drawn by dealer on a “blind” or dealer can pick any 2 cards from the deck of his choice. Dealer then places the 2 cards face up and sits them aside at Sleeping Card place on the table. These 2 cards are no longer part of the game and players can't place bets on them.

Next players start placing their bets on the cards printed on the felt cover, with the exception of the 2 “sleeping cards”. It is advised to play with chips to assure a better flow of the game. Dealer closes bets and starts dealing cards from the deck. Before each card is drawn, dealer sets aside a “Fire Card” from the top of deck, deals a card, checks against any winning bets on the table, pays off winning bet and the game continues again with setting aside a “Fire Card” before each draw. Dealer turns up card 1 to 6 (betting lines 1st pair, 2nd pair, 3rd pair) one by one, checks against the winning bets on the table and pays out the winning bets at the end of the game. Dealer draws the 7th highest winning card, but leaves the card face down. Next the dealer draws the 8^{th} Card called “Second Chance” that guarantees the player their winning chips in the amount according to the original bet on selected card to be played in the next game with the exact card played in previous game. Lastly the dealer turns the 7th and highest winning card face up. Then dealer clears all non-winning bets of the table. Then dealer pays all the winning bets and a new game starts. In the event that a sleeping card is drawn in the new game which is exactly the same as the second chance card, said dealer redraws a sleeping card removes previously drawn sleeping card and puts card back into deck and reshuffles the deck.

### BRIEF DESCRIPTION OF THE DRAWINGS

These and other details of the present invention will be described in connection with the accompanying drawings, which are furnished only by way of illustration and not in limitation of the invention, and in which drawings:

FIG. 1. is a plan view of Seven Hits card game, illustrating, a playing surface of a specially designed felt/cloth with playing and betting areas.

FIG. 1A. Is a plan view of Seven Hits card game, illustrating a playing surface with playing and betting areas.

FIG. 2. is a plan view of Seven Hits card game, illustrating a 32 deck of cards shuffled and placed onto playing surface.

FIG. 3. is an elevational view of Seven Hits card game, illustrating the dealer drawing two cards and placing both cards onto Sleeping card position onto playing field facing up.

FIG. 4. is an elevational view of Seven Hits card game, illustrating the Betting area.

FIG. 5. is an elevational view of Seven Hits card game, illustrating the dealer drawing one card and placing card onto Fire card position on playing field facing down.

FIG. 6. is an elevational view of Seven Hits card game, illustrating the dealer drawing one card and placing card onto 2× BET position onto right side of playing field facing up.

FIG. 7. is an elevational view of Seven Hits card game, illustrating the dealer moving winning chips of original bet to designated area labeled 2× BET onto right side of playing field.

FIG. 8. is an elevational view of Seven Hits card game, illustrating the dealer drawing one card and placing card onto Fire card position onto playing field facing down.

FIG. 9. is an elevational view of Seven Hits card game, illustrating the dealer drawing one card and placing card onto 2× BET position onto left side of playing field facing up.

FIG. 10. is an elevational view of Seven Hits card game, illustrating the dealer moving winning chips of original bet to designated area labeled 2× BET onto left side of playing field.

FIG. 11. is an elevational view of Seven Hits card game, illustrating the dealer drawing one card and placing card onto Fire card position onto playing field facing down.

FIG. 12. is an elevational view of Seven Hits card game, illustrating the dealer drawing one card and placing card onto 3× BET position on right side of playing field facing up.

FIG. 13. is an elevational view of Seven Hits card game, illustrating the dealer moving winning chips of original bet to designated area labeled 3× BET onto right side of playing field.

FIG. 14. is an elevational view of Seven Hits card game, illustrating the dealer drawing one card and placing card onto Fire card position onto playing field facing down.

FIG. 15. is an elevational view of Seven Hits card game, illustrating the dealer drawing one card and placing card onto 3× BET position onto left side of playing field facing up.

FIG. 16. is an elevational view of Seven Hits card game, illustrating the dealer moving winning chips of original bet to designated area labeled 3× BET onto left side of playing field.

FIG. 17. is an elevational view of Seven Hits card game, illustrating the dealer drawing one card and placing card onto Fire card position onto playing field facing down.

FIG. 18. is an elevational view of Seven Hits card game, illustrating the dealer drawing one card and placing card onto 4× BET position onto right side of playing field facing up.

FIG. 19. is an elevational view of Seven Hits card game, illustrating the dealer moving winning chips of original bet to designated area labeled 4× BET onto right side of playing field.

FIG. 20. is an elevational view of Seven Hits card game, illustrating the dealer drawing one card and placing card onto Fire card position onto playing field facing down.

FIG. 21. is an elevational view of Seven Hits card game, illustrating the dealer drawing one card and placing card onto 4× BET position onto left side of playing field facing up.

FIG. 22. is an elevational view of Seven Hits card game, illustrating the dealer moving winning chips of original bet to designated area labeled 4× BET onto left side of playing field.

FIG. 23. is an elevational view of Seven Hits card game, illustrating the dealer drawing one card and placing card onto Fire card position onto playing field facing down.

FIG. 24. is an elevational view of Seven Hits card game, illustrating the dealer drawing one card and placing card onto 10× BET position onto center of playing field facing down.

FIG. 25. is an elevational view of Seven Hits card game, illustrating the dealer drawing one card and placing card onto Fire card position on playing field facing down.

FIG. 26. is an elevational view of Seven Hits card game, illustrating the dealer drawing one card and placing card onto 2^{nd} Chance position onto center of playing field facing up.

FIG. 27. is an elevational view of Seven Hits card game, illustrating the dealer leaving winning chips of 2^{nd} Chance of said player in the amount according to the original bet on selected card on the playing field.

FIG. 28. is an elevational view of Seven Hits card game, illustrating the dealer turning 10× BET card upwards revealing winning card.

FIG. 29. is an elevational view of Seven Hits card game, illustrating the dealer moving winning chips of original bet to designated area labeled 10× BET onto center of playing field.

FIG. 30. is an elevational view of Seven Hits card game, illustrating the dealer clearing all non-winning bets from the betting area.

FIG. 31. is an elevational view of Seven Hits card game, illustrating the dealer paying all winning bets on playing field.

FIG. 32. is an elevational view of Seven Hits card game, illustrating the dealer moving winning chips of original bet of 2^{nd} chance winner forward to the next game in the exact amount allowing player to enter the next game with same bet onto the betting area. *** (in the event that a sleeping card is drawn that is exactly the same as the second chance card said dealer draws a new sleeping card, puts previously drawn sleeping card back into deck and reshuffles the deck).

### DETAILED DESCRIPTION

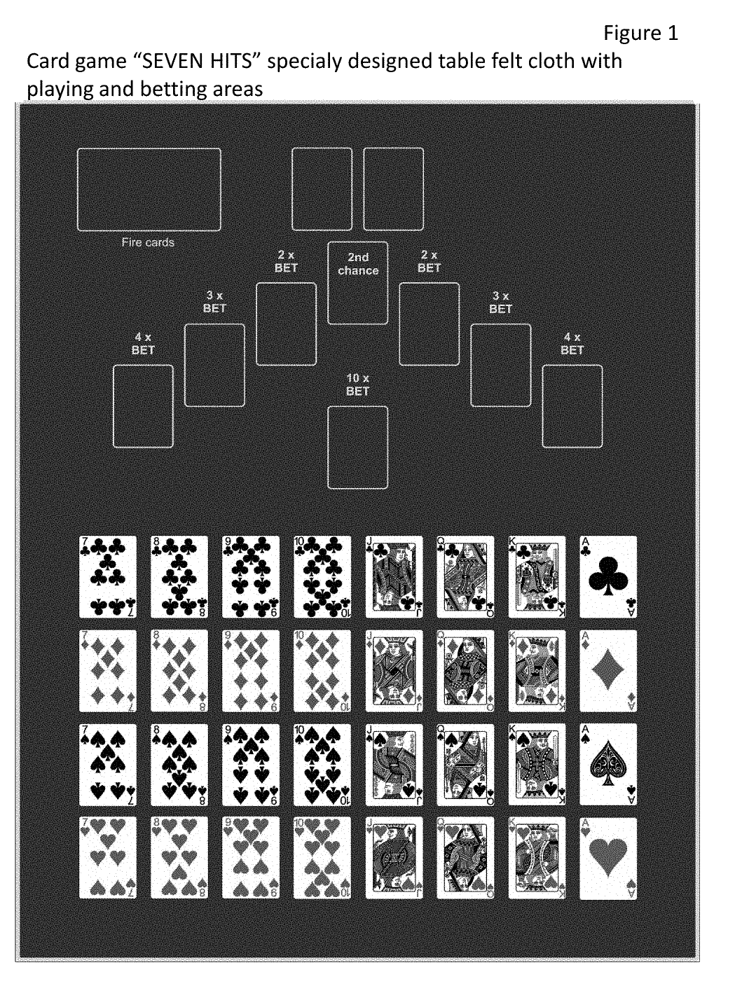

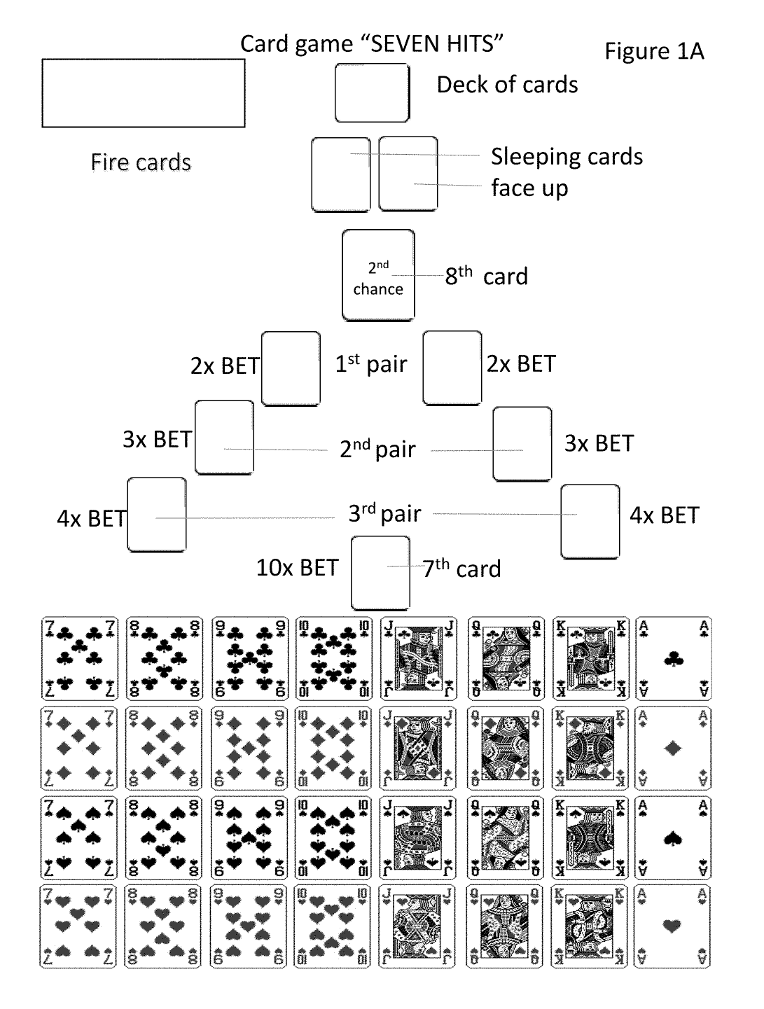

In FIGS. 1-5, a method for a Seven Hits Casino card game begins with the dealer shuffling a deck of cards, then Dealer picks 2 cards from the deck called “Sleeping Cards”. Sleeping cards can be drawn by Dealer on a “blind” or Dealer can pick any 2 cards from the deck of his choice. Dealer then turns the 2 cards face up and sets them aside at Sleeping Card place on the table. These 2 cards are no longer part of the game and players can't place bets on them.

Next players start placing their bets on the cards printed on the felt cover, with the exception of the 2 “sleeping cards”. It is advised to play with chips to assure a better flow of the game. Dealer closes bets and starts dealing cards from the deck. Before each card draw, Dealer sets aside a “Fire Card” from the top of deck and places in face down.

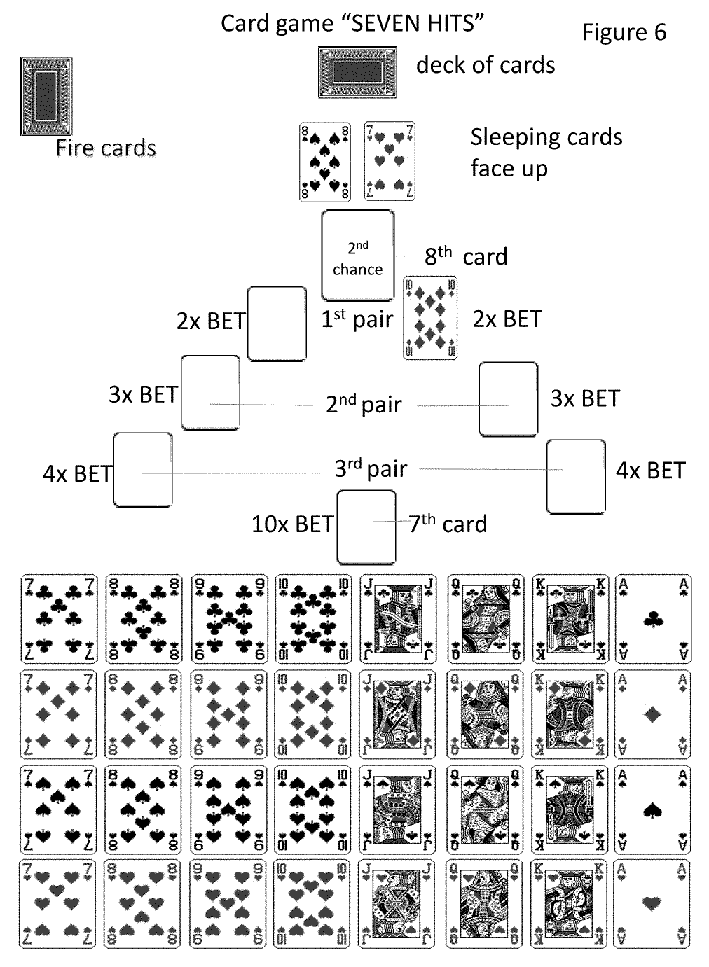

In FIGS. 6-8. the method for a Seven Hits Casino card game comprises dealer dealing a card and placing it face up on the area labeled 2 XBET right side of playing area, dealer checks against any winning bets on the table, moves winning bet to 2× BET right side of playing area, and the game continues again with setting aside a “Fire Card” before each draw.

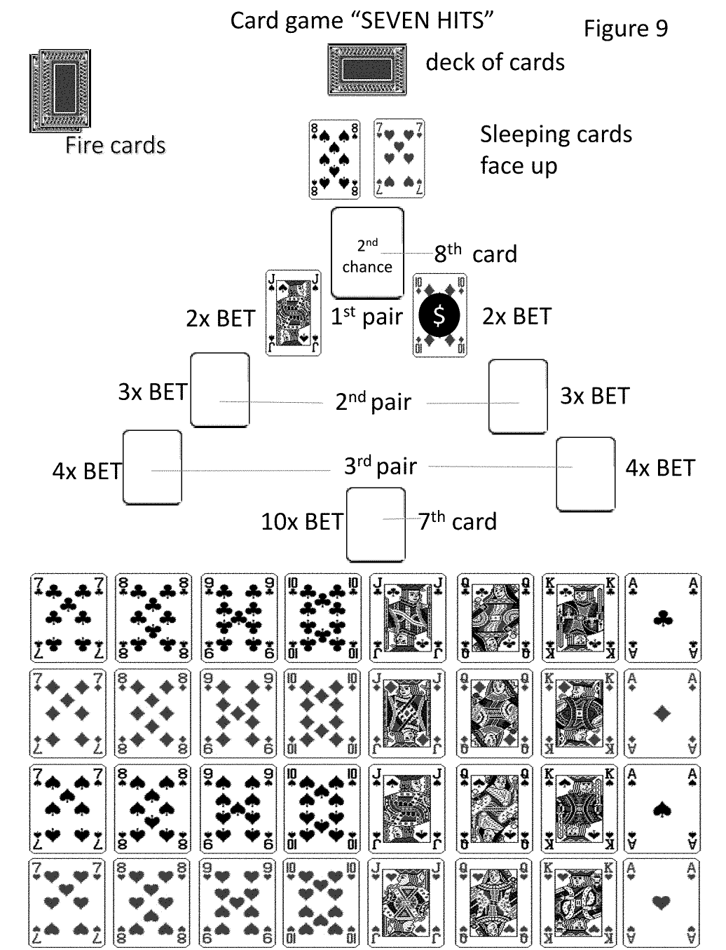

In FIGS. 9-11. the method for a Seven Hits Casino card game comprises dealer dealing a card and placing it face up on the area labeled 2 XBET Left side of playing area, dealer checks against any winning bets on the table, moves winning bet to 2× BET Left side of playing area, and the game continues again with setting aside a “Fire Card” before each draw.

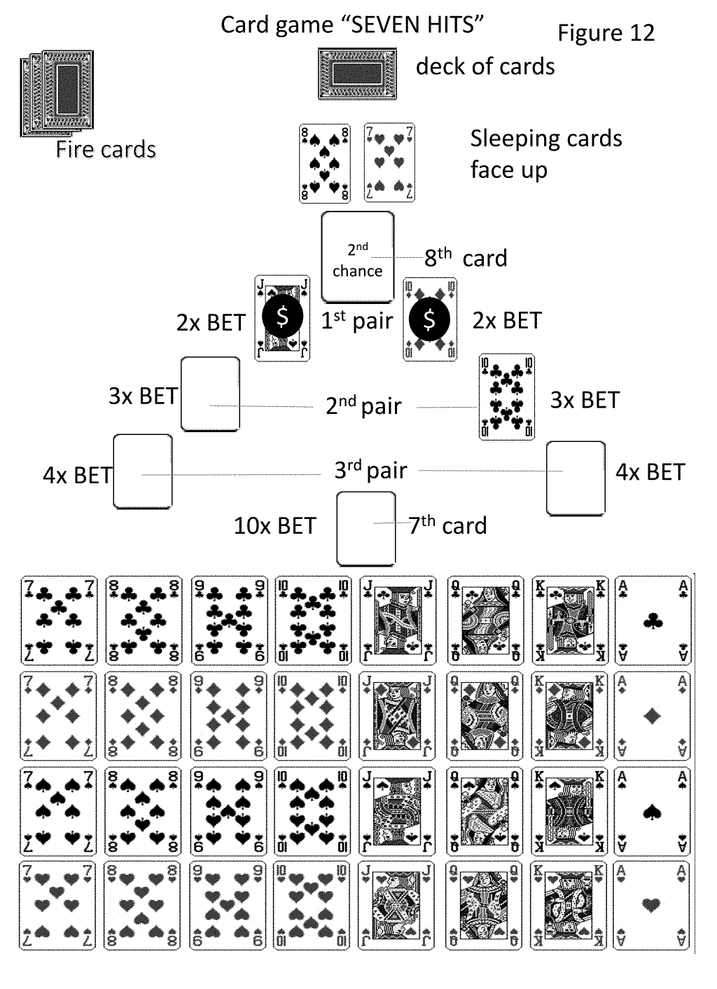

In FIGS. 12-14. the method for a Seven Hits Casino card game comprises dealer dealing a card and placing it face up on the area labeled 3× BET Right side of playing area, dealer checks against any winning bets on the table, moves winning bet to 3× BET Right side of playing area, and the game continues again with setting aside a “Fire Card” before each draw.

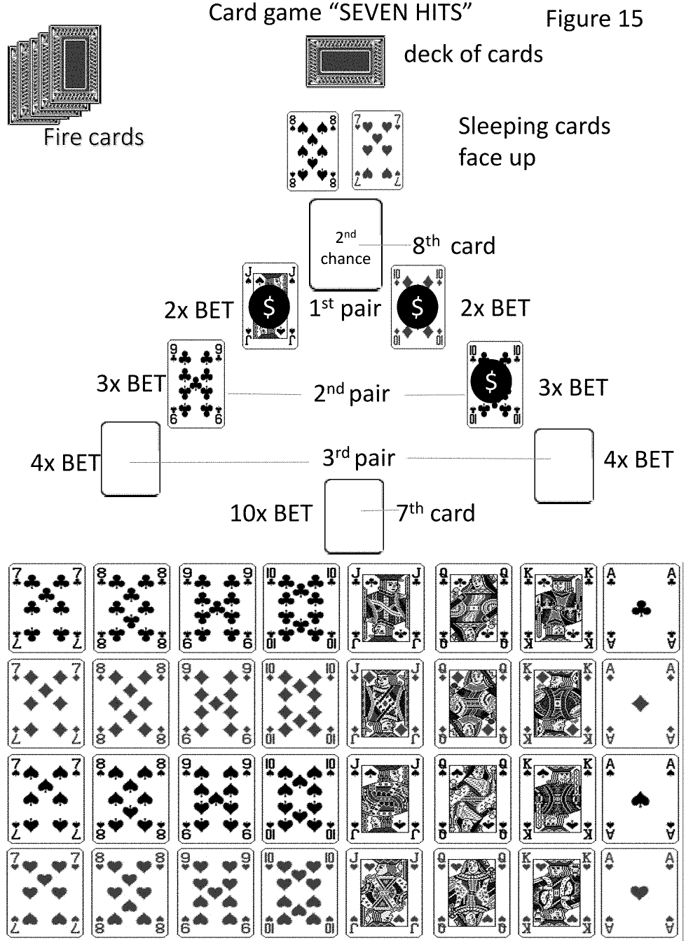

In FIGS. 15-17. the method for a Seven Hits Casino card game comprises dealer dealing a card and placing it face up on the area labeled 3 XBET Left side of playing area, dealer checks against any winning bets on the table, moves winning bet to 3× BET Left side of playing area, and the game continues again with setting aside a “Fire Card” before each draw.

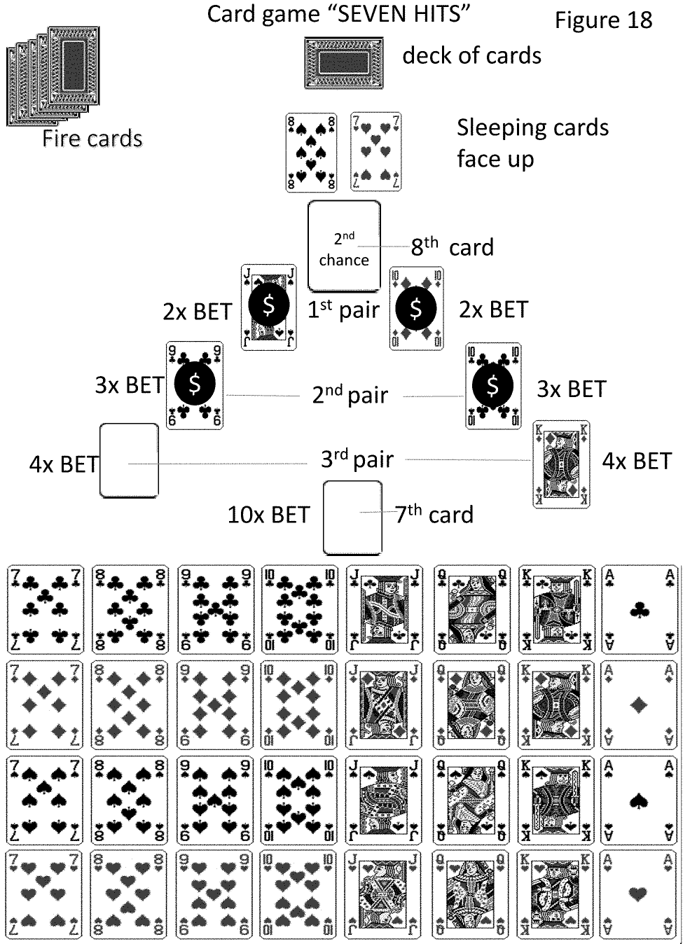

In FIGS. 18-20. the method for a Seven Hits Casino card game comprises dealer dealing a card and placing it face up on the area labeled 4× BET Right side of playing area, dealer checks against any winning bets on the table, moves winning bet to 4× BET Right side of playing area, and the game continues again with setting aside a “Fire Card” before each draw.

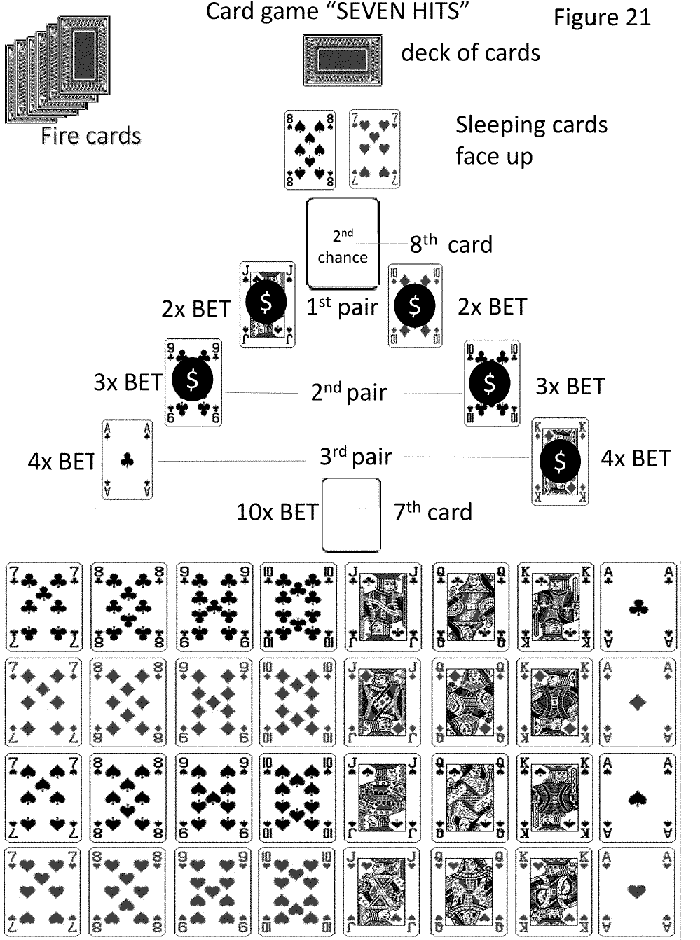

In FIGS. 21-23. the method for a Seven Hits Casino card game comprises dealer dealing a card and placing it face up on the area labeled 4 XBET Left side of playing area, dealer checks against any winning bets on the table, moves winning bet to 4× BET Left side of playing area, and the game continues again with setting aside a “Fire Card” before each draw.

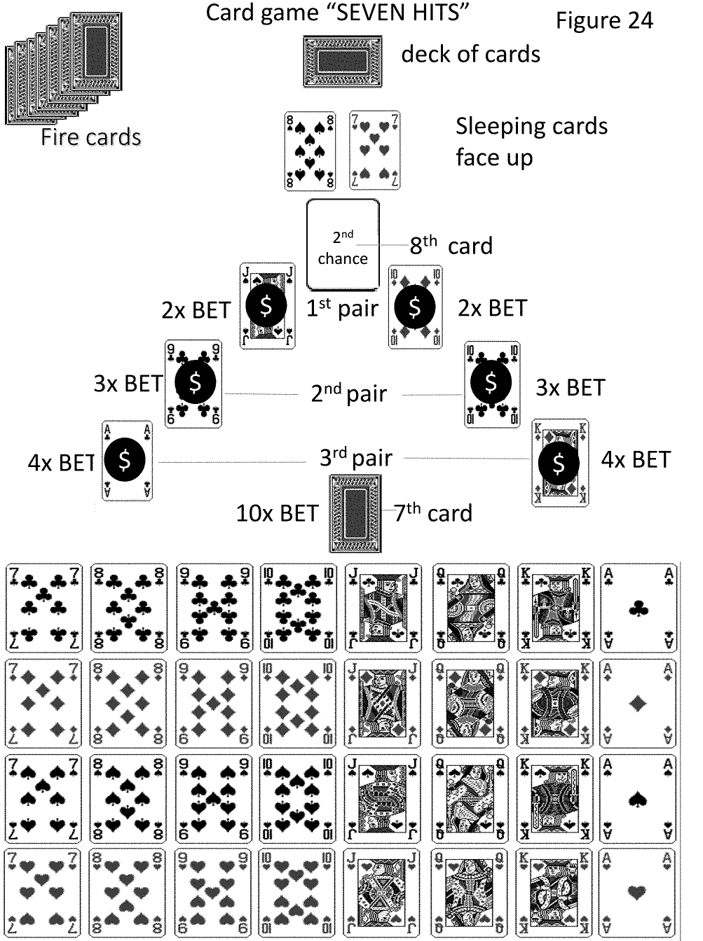

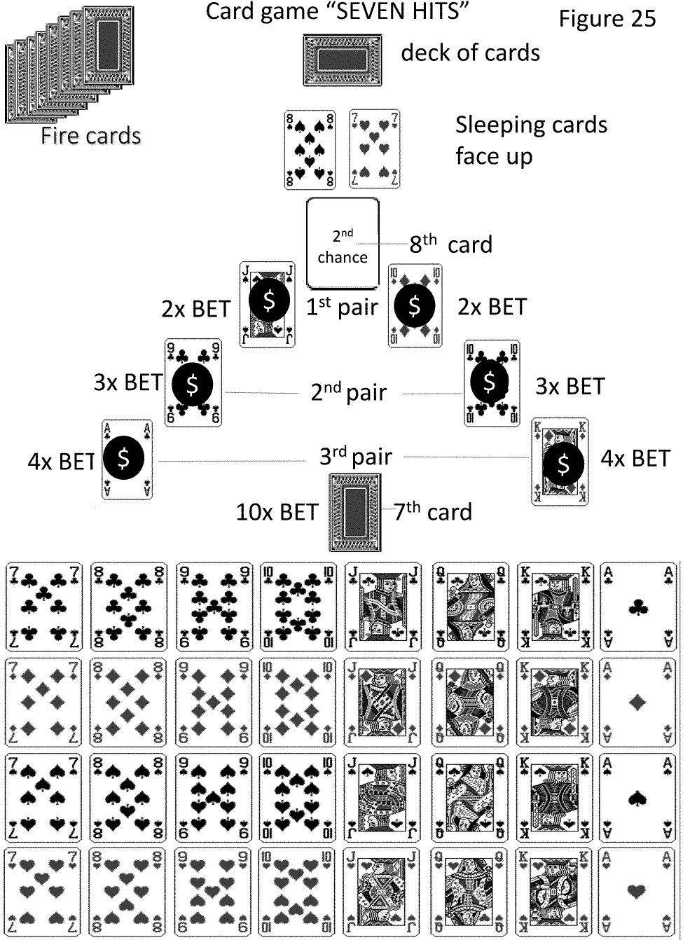

In FIGS. 24-25. the method for a Seven Hits Casino card game comprises dealer dealing a card and placing it face down on the area labeled 10× BET Center of playing area, dealer draws one card and placing card onto Fire card position on playing field facing down. The game continues to next movement but no winning bets are validated at this time for 10× BET position.

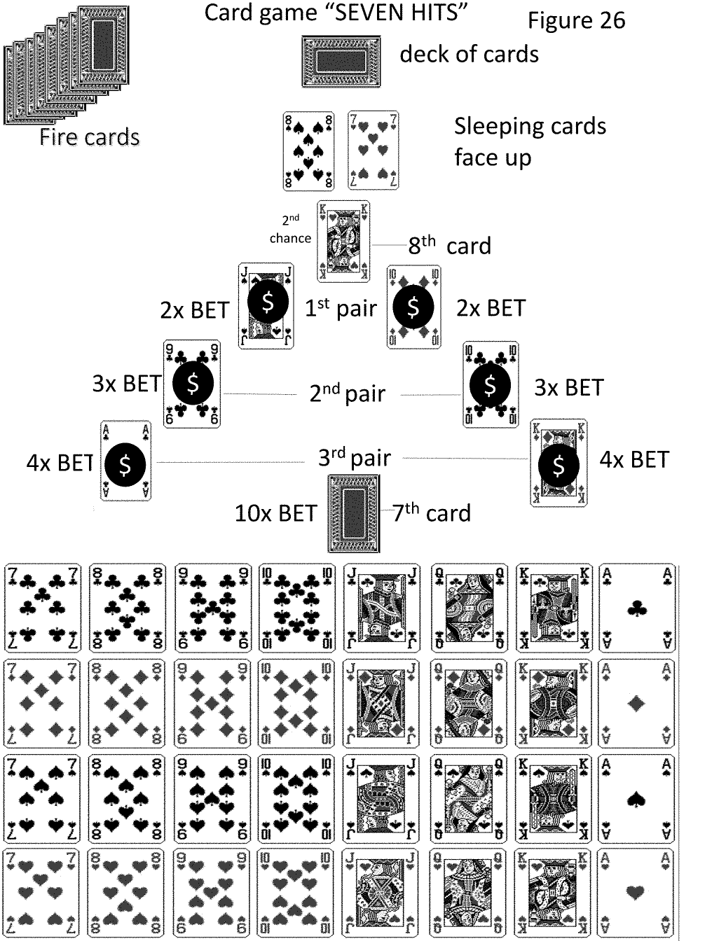

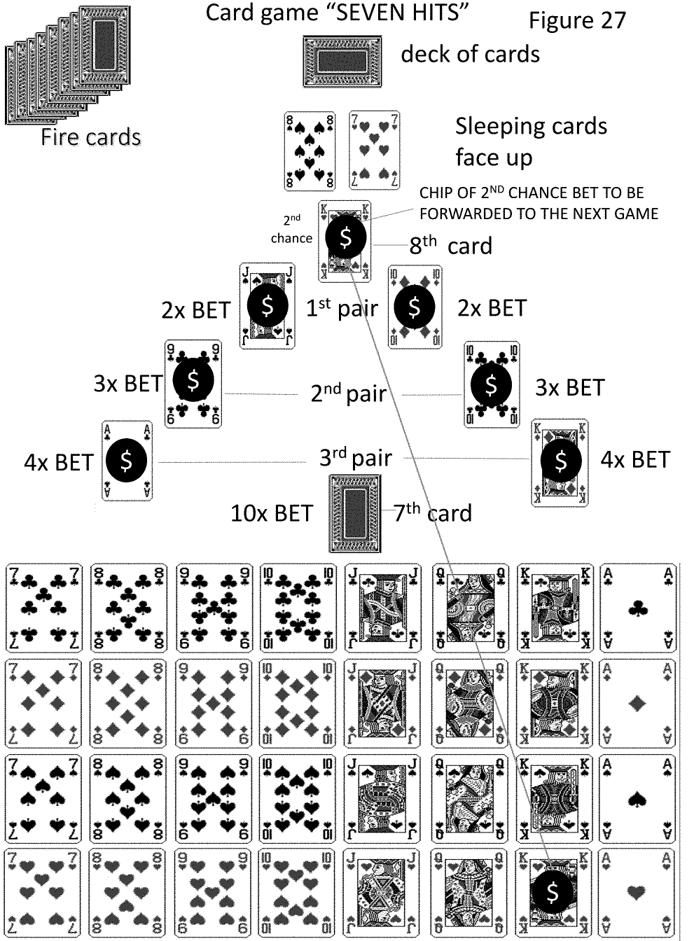

In FIGS. 26-27. the method for a Seven Hits Casino card game comprises dealer dealing a card and placing it face up on the area labeled 2^{nd} Chance Center of playing area, the dealer moves and leaves winning chips of 2^{nd} Chance of said player in the amount according to the original wager on selected card on the playing area. The dealer will place 2^{nd} Chance bet forward to the next game in the exact amount allowing player to enter the next game with card. The game continues to next movement and final movement.

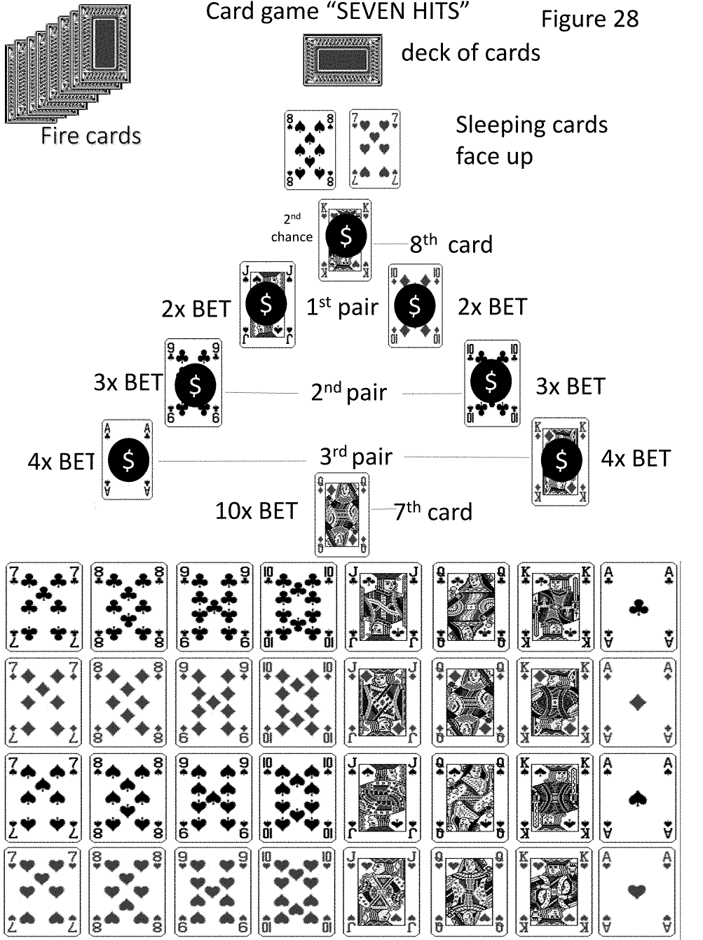

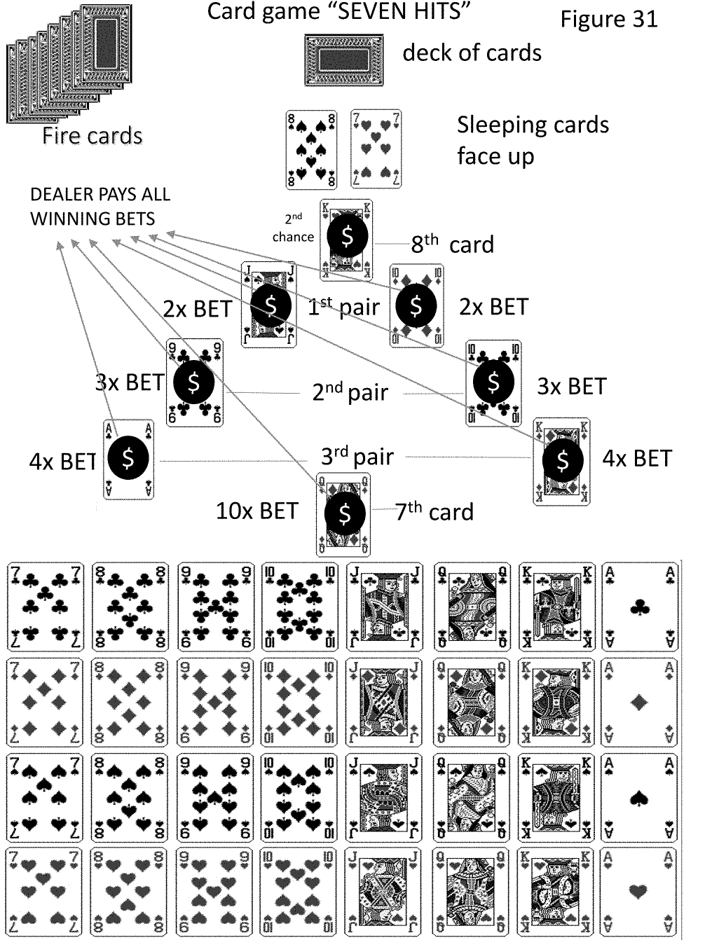

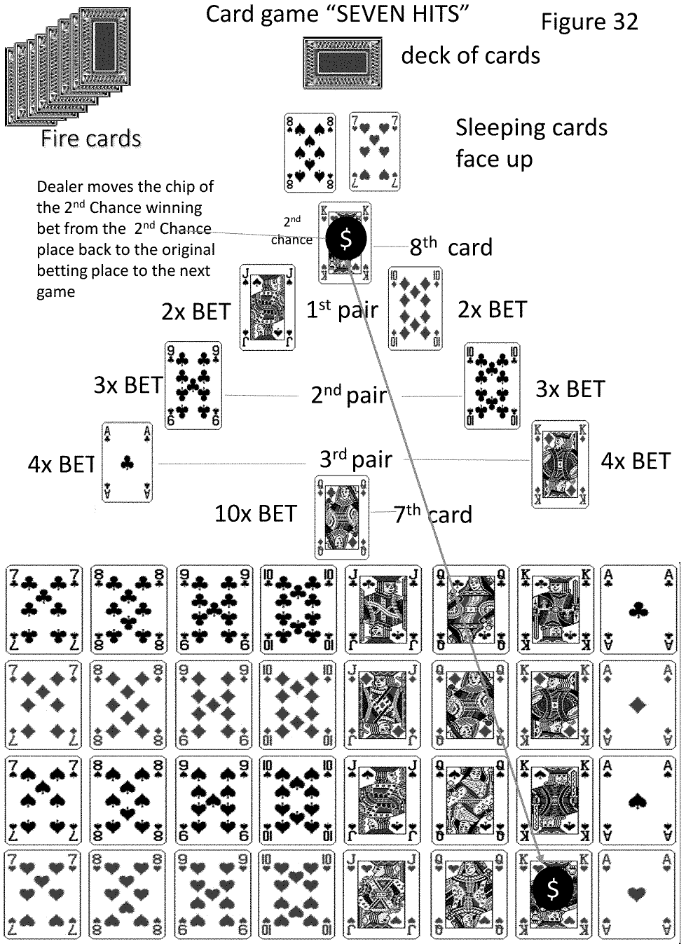

In FIGS. 28-32. The method for a Seven Hits Casino card game comprises the dealer turns 10× BET card upwards revealing winning card. Dealer checks against any winning bets on the table and moves winning bet to 10× BET center of the playing area. Then Dealer clears all non-winning bets off the table. All bets are validated and dealer pays all winning bets and a new game starts. In the event that a sleeping card is drawn in the new game which is exactly the same as the second chance card said dealer redraws a sleeping card removes previously drawn sleeping card and puts card back into deck and reshuffles the deck.

### Payoffs are Defined as Follows:

1) The first pair of cards (cards 1 and 2) of the rotated package guarantees players who bet on them to win twice the bet amount.
2) A second pair of cards (cards 3 and 4) guarantees to win three times the bet amount.
3) The third pair of cards (cards 5 and 6) guarantees to win four times the bet amount.
4) Eight card will return the bet amount back to the winning player by moving to next game.
4) Seventh card guarantees to win the ten times of the bet amount.
5) All the non-winning card bets go to Casino and the dealer ends the game.

### Additional Game Notes:

1) For better game flow it is possible for the dealer to move the winning chips after each draw and place them on the winning cards and pay all the bets at once at the ends of the game when the last 7th card has been revealed.
2) Minimum of 1 player to play, maximum amount to be established by Casino
3) Table limits to be established by Casino
4) Bets can be placed on 1 card or on all 32 cards with the exception of the 2 “Sleeping Cards”

### Potential Game Modification and Additions:

1) Game could be played with a deck up to 52 cards, table cover would have to reflect all 52 cards from A to 2.
2) Game could be played without one or both “Sleeping Cards”, and this could change the amount of eligible betting cards, i.e. for deck of 32 cards we can have from 30-32 eligible betting cards and for deck of 52 cards we can have from 50 up to 52 eligible betting cards.
3) Game could be played without the 8th Second Chance Card
4) Casinos could use any playing cards to their liking, just need to be reflected on the playing table cover.
5) Seven Hits card game could be played as a Seven Hits Slot Machine game, as an online casino game, mobile application game.
6) Seven Hits card game can be manufactured and sold in general stores as a table game for mass public use.

It is understood that the preceding description is given merely by way of illustration, not in limitation of the invention, and that various modifications may be made thereto without departing from the spirit of the invention as claimed.

What is claimed is:

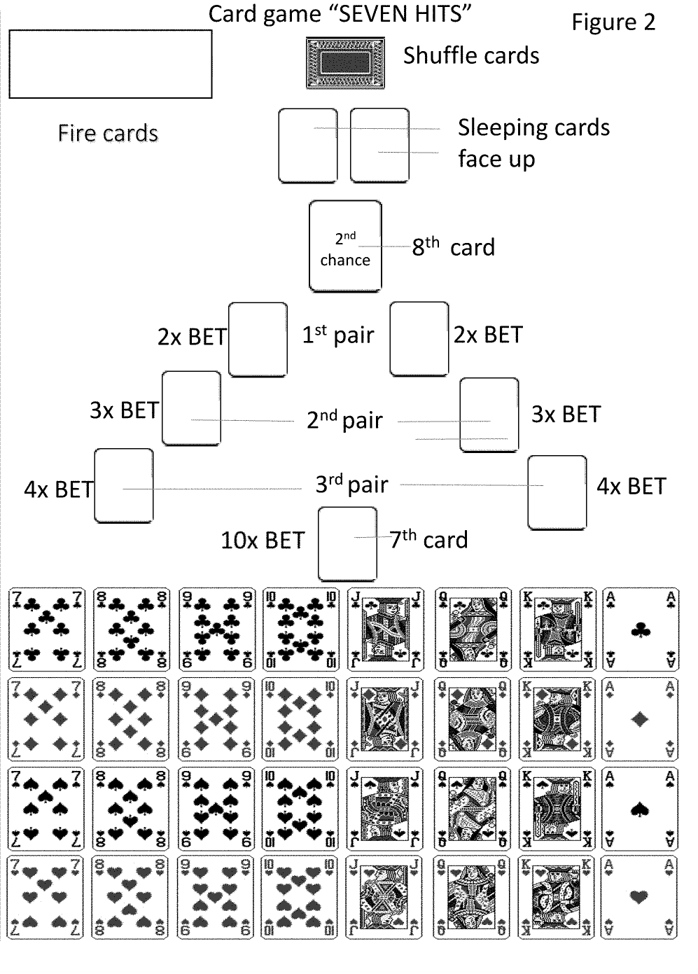

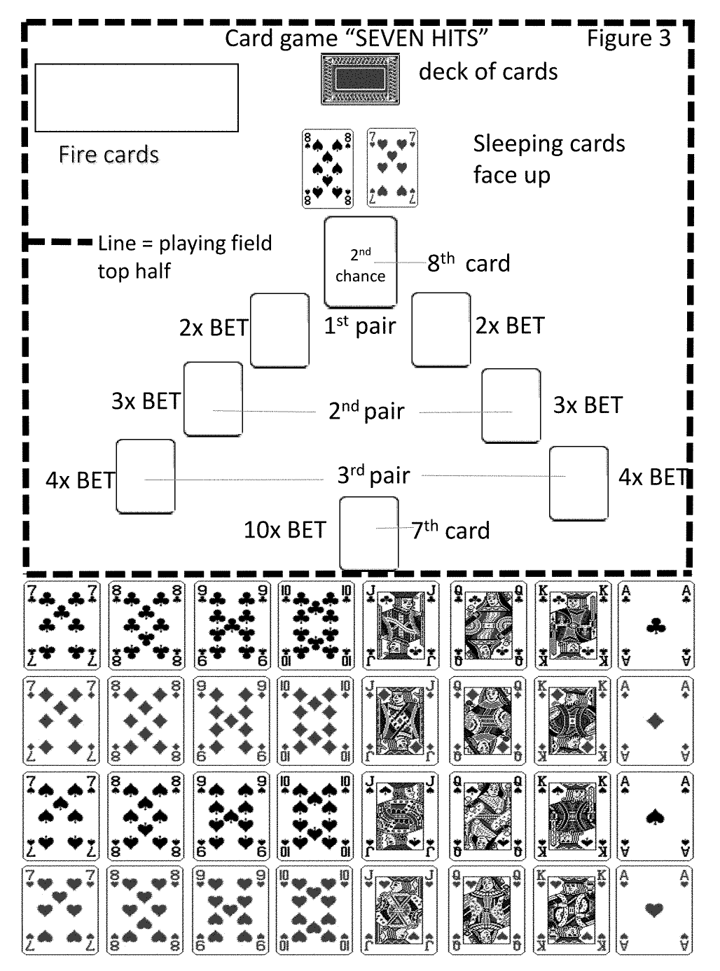

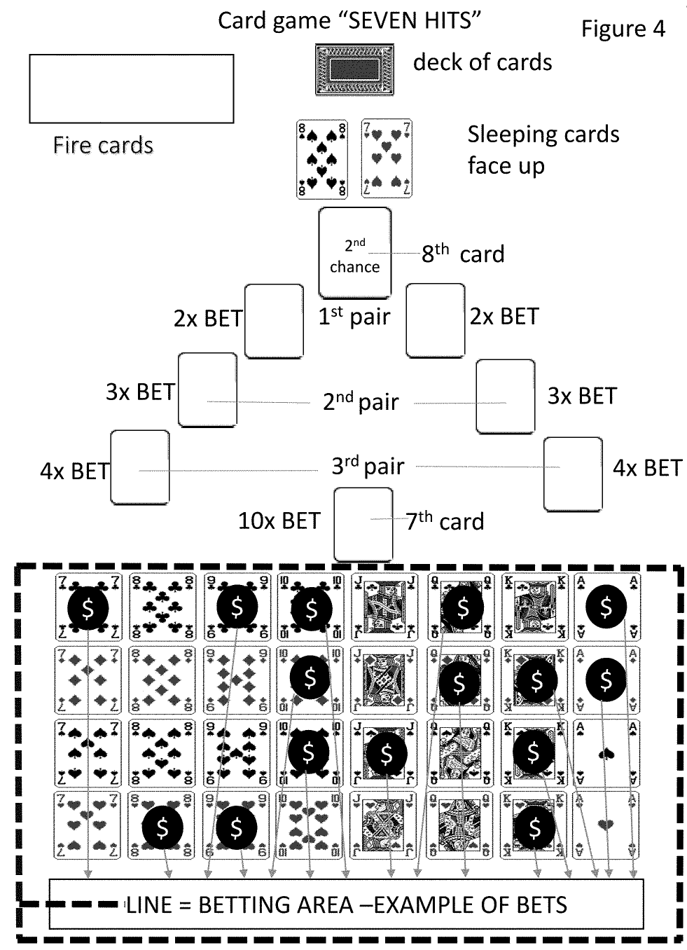

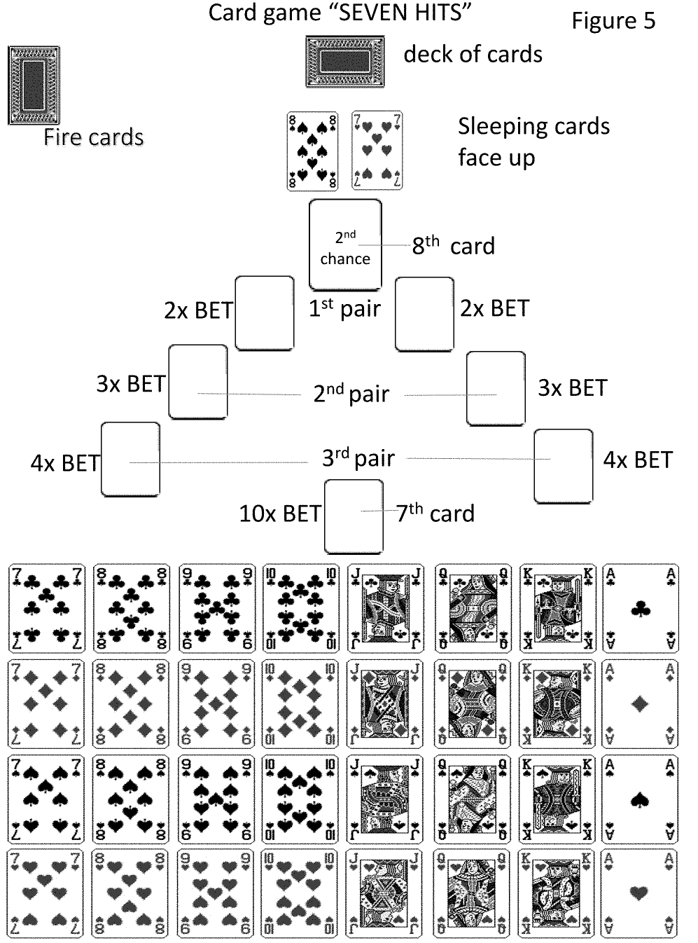

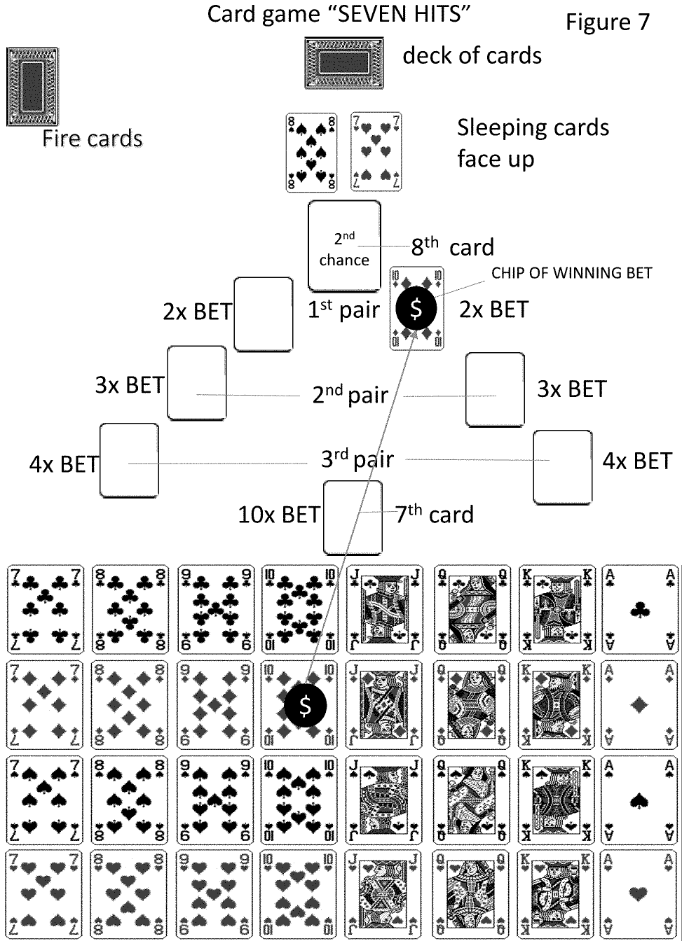

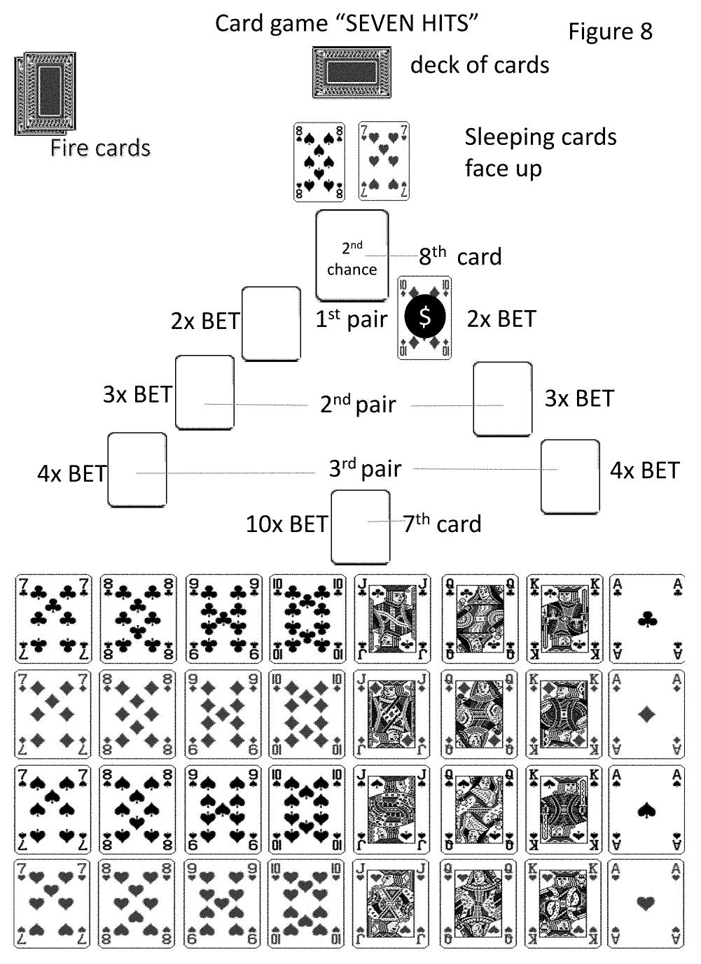

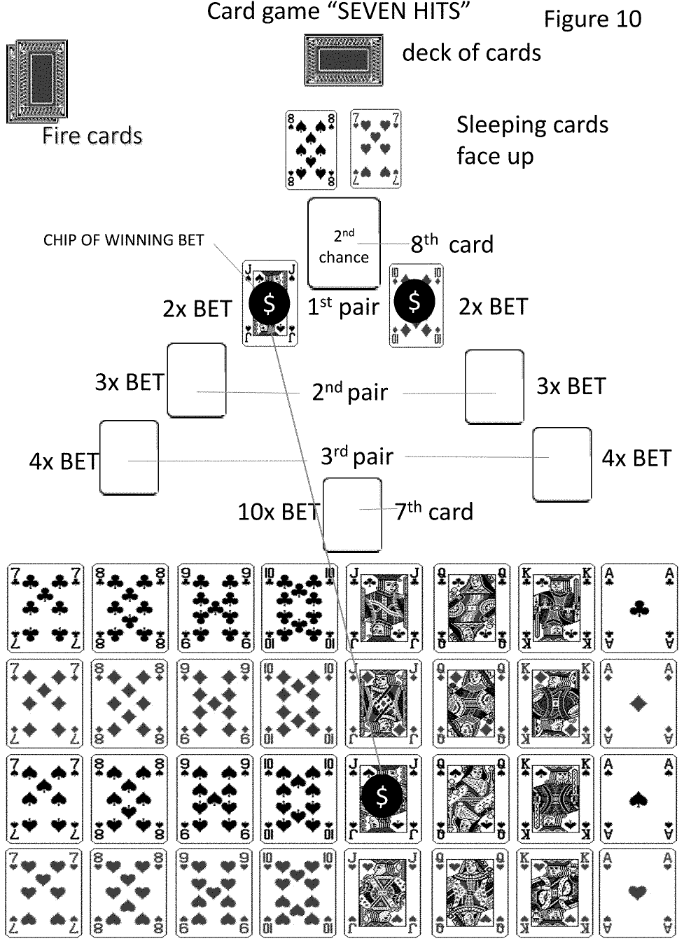

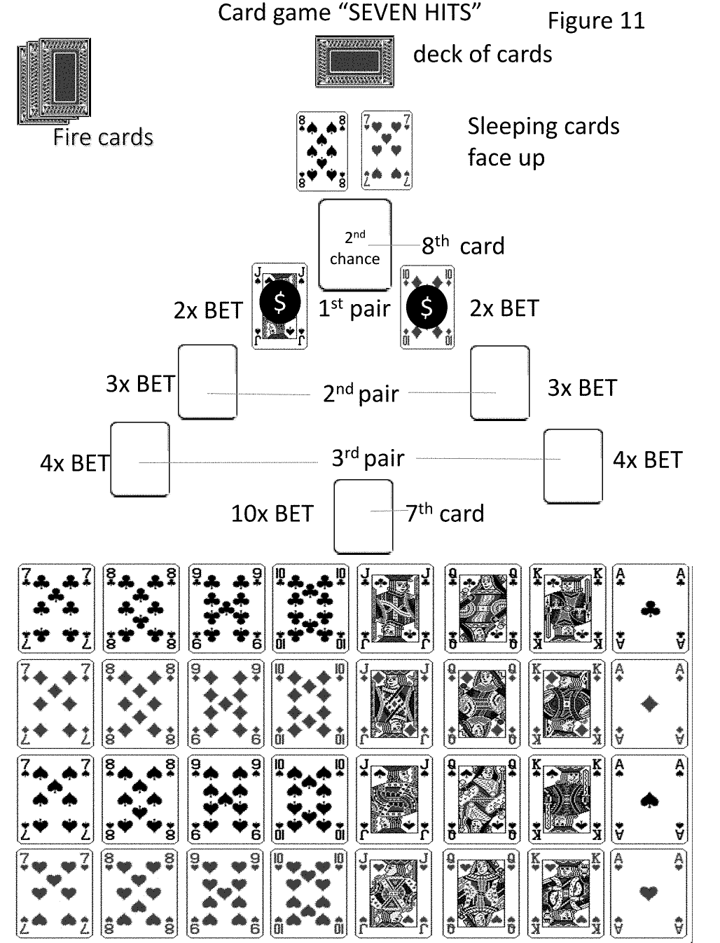

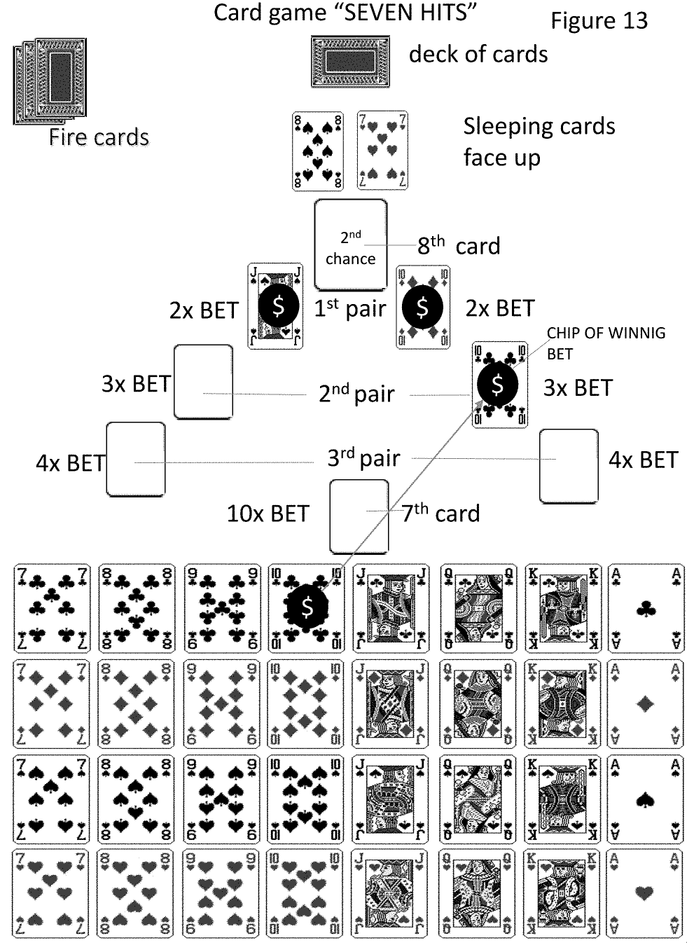

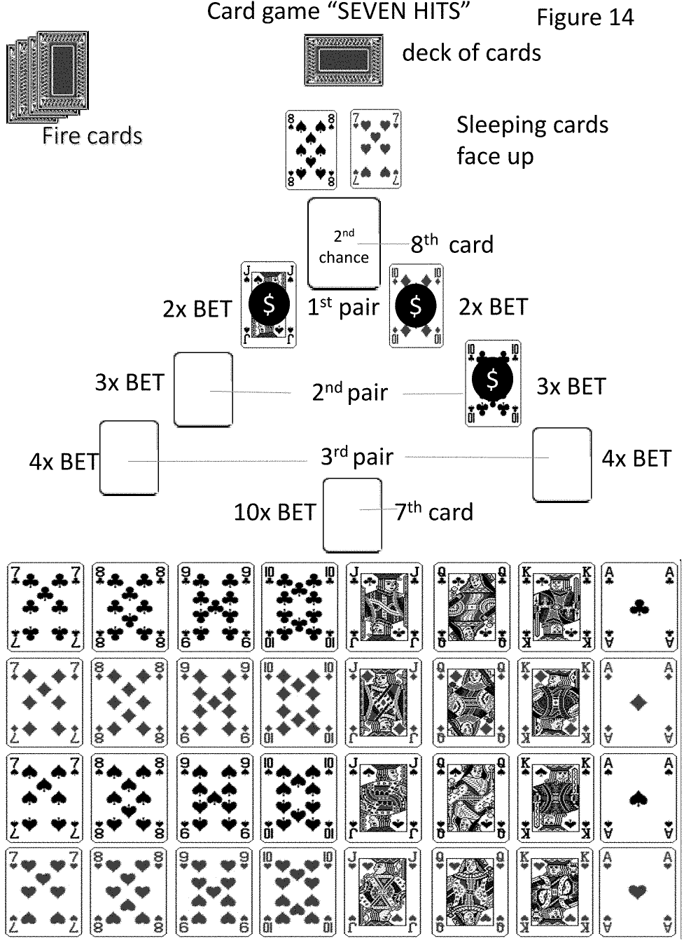

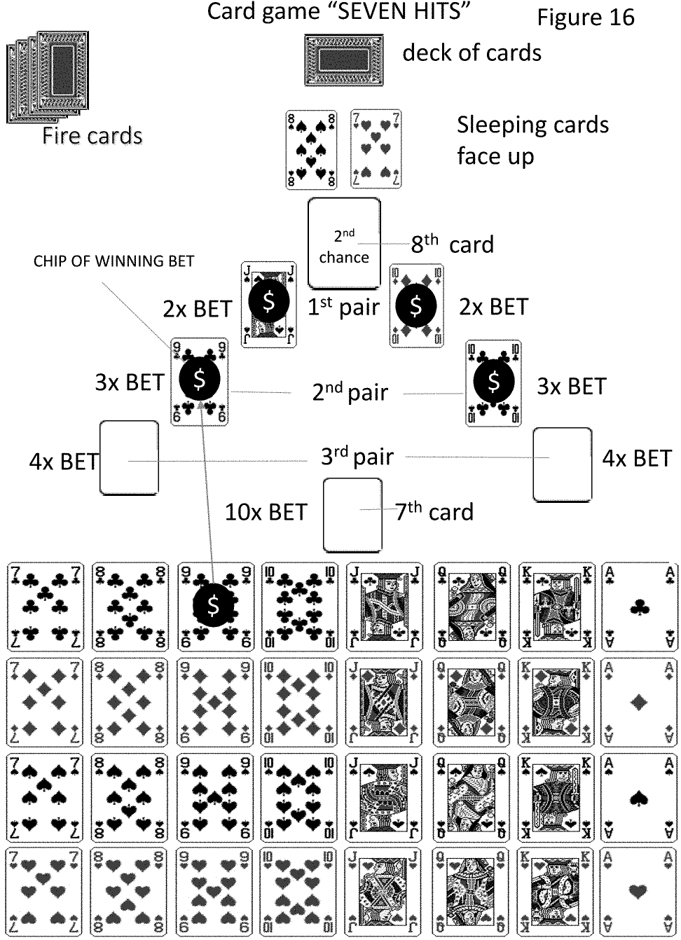

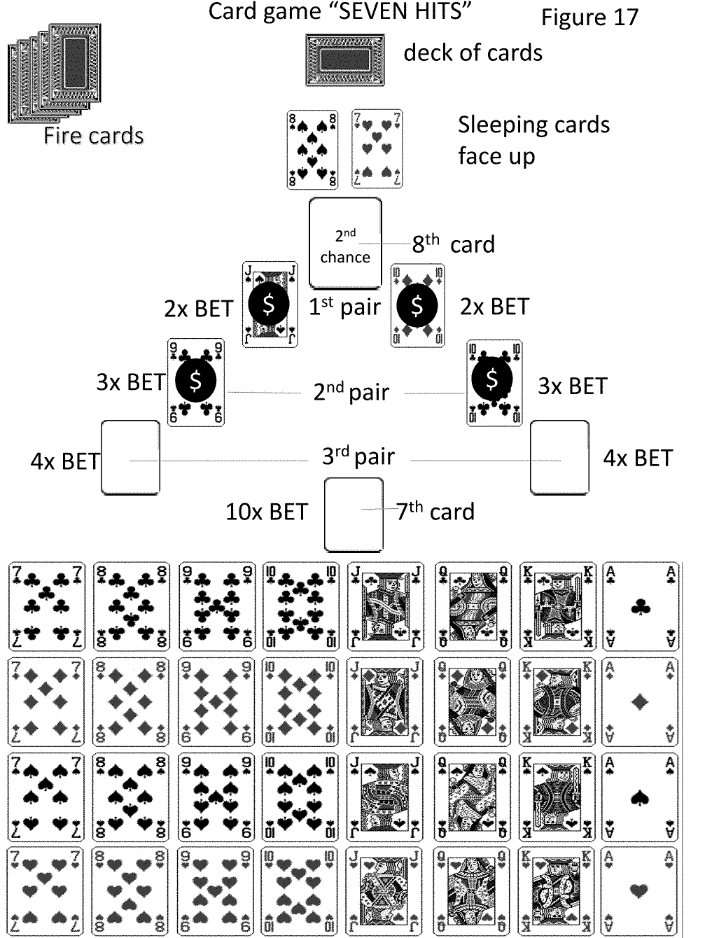

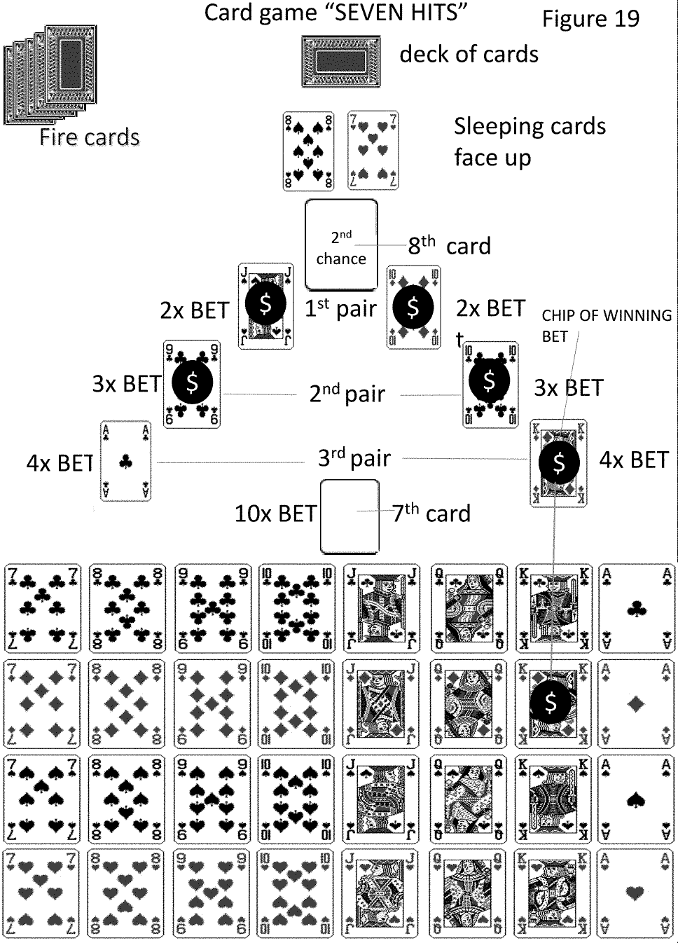

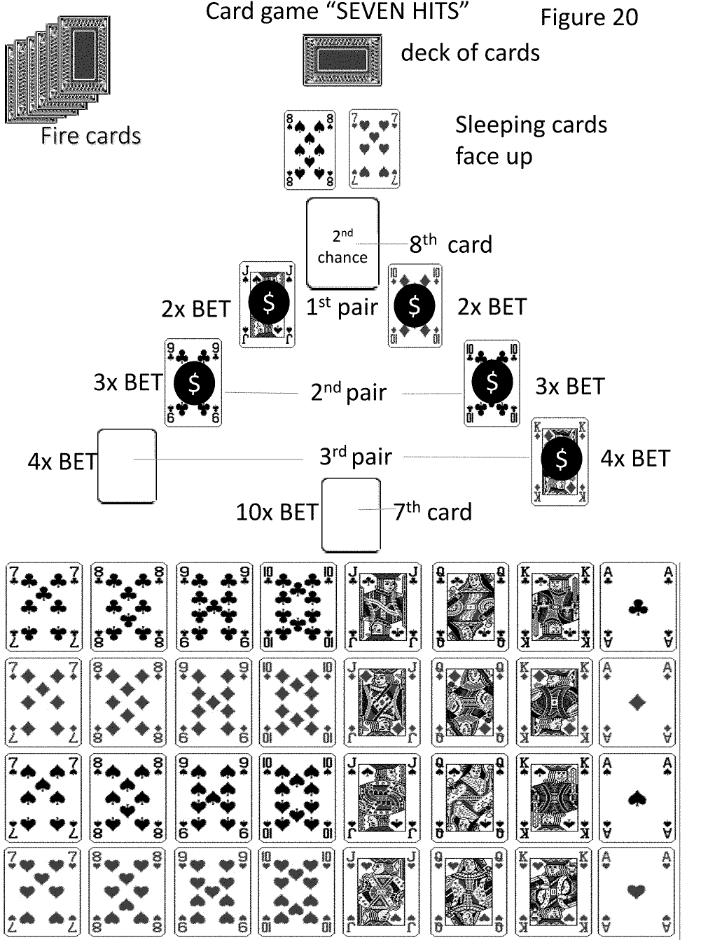

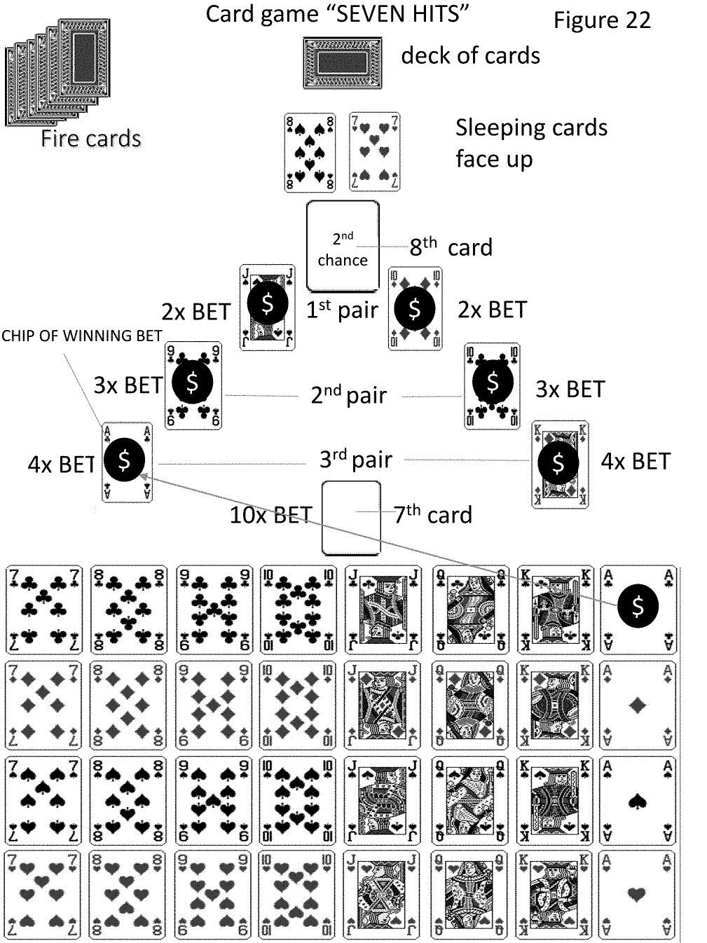

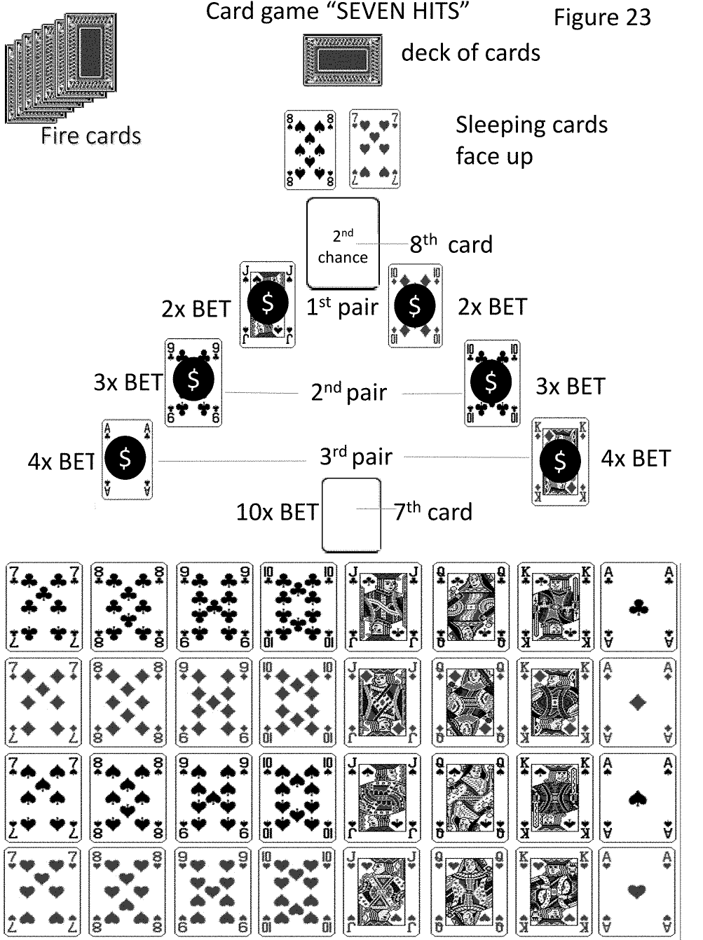

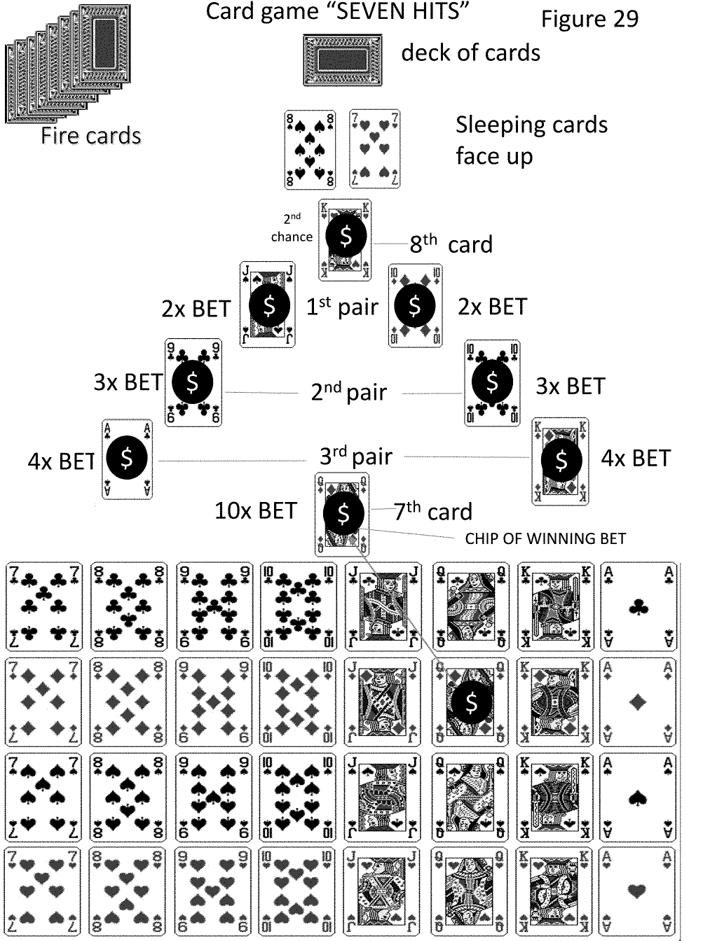

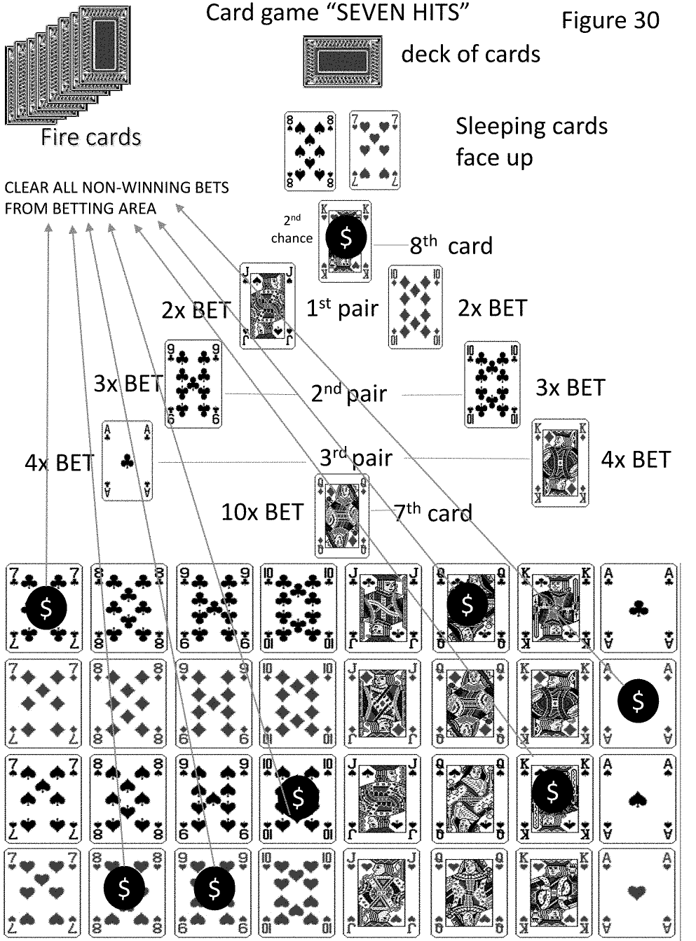

1. A method of playing a card game (Seven Hits) utilizing a master deck including one 32 card deck of standard playing cards which are ranked from low to high in the order of 7, 8, 9, 10, Jack, Queen, King and Ace, and playing on a surface specially designed felt/cloth (See FIG. 1), comprising the steps of:
(a) a dealer shuffles a deck of cards and places shuffled cards (See FIG. 2), then dealing two cards “Sleeping Cards” (see FIG. 3) face up on said playing surface marked “Sleeping card (see FIG. 3), these two cards are no longer part of the game and wagers are not allowed on the two sleeping cards;
(b) at least one player or more place a bet onto one of 32 marked spaces on a playing surface (See FIG. 4) located on bottom half with images of playing cards 7, 8, 9, 10, Jack, Queen, King and Ace;
(c) dealer stops accepting bets and closes bets on playing surface (see FIG. 4);
(d) before each card draw said dealer sets aside a “Fire card” (see FIG. 5) from the top of deck placing the card facing down, then said dealer draws another card and placing it on the right side of playing surface face up labeled 2× bet spot (see FIG. 6), said dealer moves winning chip of said player on said playing surface labeled 2× bet spot right side (see FIG. 7);
(e) next said dealer draws one more/another “Fire card” and places drawn “Fire card” face down into Fire card pile (see FIG. 8), then said dealer draws another card and placing it on the left side of playing surface face up labeled 2× bet spot (see FIG. 9), said dealer moves winning chip of said player on said playing surface labeled 2× bet spot left side (see FIG. 10);
(f) next said dealer draws one more/another “Fire card” and places drawn “Fire card” face down into Fire card pile (see FIG. 11), then said dealer draws another card and placing it on the right side of playing surface face up labeled 3× bet spot (see FIG. 12), said dealer moves winning chip of said player on said playing surface labeled 3× bet spot right side (see FIG. 13);
(g) next said dealer draws one more/another “Fire card” and places drawn “Fire card” face down into Fire card pile (see FIG. 14), then said dealer draws another card and placing it on the left side of playing surface face up labeled 3× bet spot (see FIG. 15), said dealer moves winning chip of said player on said playing surface labeled 3× bet spot, left side (see FIG. 16);
(h) next said dealer draws one more/another “Fire card” and places drawn “Fire card” face down into Fire card pile (see FIG. 17), then said dealer draws another card and placing it on the right side of playing surface face up labeled 4× bet spot (see FIG. 18), said dealer moves winning chip of said player on said playing surface labeled 4× bet spot right side (see FIG. 19);
(i) next said dealer draws one more/another “Fire card” and places drawn “Fire card” face down into Fire card pile (see FIG. 20), then said dealer draws another card and placing it on the left side of playing surface face up labeled 4× bet spot (see FIG. 21), said dealer moves winning chip of said player on said playing surface labeled 4× bet spot left side (see FIG. 22);
(j) next said dealer draws one more/another “Fire card” and places drawn “Fire card” face down into Fire card pile (see FIG. 23)′, then said dealer draws another card and placing it on the playing surface face up labeled 10× bet spot (see FIG. 24) card facing down;
(k) next said dealer draws one more/another “Fire card” and places drawn “Fire card” face down into Fire card pile (see FIG. 25), then said dealer draws another card and placing it on the playing, surface face up labeled Second Chance (see FIG. 26), said dealer leaves winning chips of said player in the amount according to the original bet on selected card on the playing field (see FIG. 27) moving, original bet to the next game.
(l) next said dealer turns 10× bet card face up (see FIG. 28), said dealer moves winning chip of said player an amount according to predetermined odds posted on said playing surface labeled 10× bet spot (see FIG. 29);
(m) next said dealer clears all non-winning bets from betting area (see FIG. 30);
(n) next said dealer pays off all winning bets of said player an amount according to predetermined odds posted on said playing surface labeled next to their winning chip, ending the game.
